(19) United States
(12) Patent Application Publication
(10) Pub. No.: US 2006/0064910 A1
(43) Pub. Date: Mar. 30, 2006

(54) Advertising methods

(76) Inventor: Shane Shankle, Arlington, TX (US)

Correspondence Address: FULBRIGHT & JAWORSKI L.L.P., 600 CONGRESS AVE., SUITE 2400, AUSTIN, TX, 78701, US

(21) Appl. No.: 10/950,153

(22) Filed: Sep. 25, 2004

(51) Int. Cl. G09F 7/12

(52) U.S. Cl. 40/594

(57) ABSTRACT

Advertising methods involving one or more portable toilets.

### BACKGROUND

1. Field of the Invention

The present invention concerns advertising methods related to one or more portable toilets that can have one or more sit-down toilets and/or one or more urinals.

2. Description of Related Art

Portable toilets are well known. Companies that rent, deliver and remove the portable toilets sometimes place their own advertising (“portable toilet advertisements”) on the exterior of the portable toilets. A “non-portable toilet advertisement” is defined as an advertisement for something other than the services of the company that rents, delivers and removes the portable toilet. Some patents also disclose the use of portable toilet advertisement systems and/or advertisements on exterior surfaces of portable toilets. See U.S. Pat. Nos. D452,901, 5,429,148, 5,647,074, 6,349,426, 6,668,392, and 6,763,626.

“Portable toilets” have also been called “porta toilets” or “portable sanitation units.” The term “portable toilet” is defined as not including “automatic public toilets,” which are sometimes called “automatic self cleaning public toilets.” Advertising space has been sold in conjunction with automatic public toilets.

### SUMMARY

Some embodiments of the present advertising methods include securing an advertisement to an interior surface of a wall or a door of a portable toilet that has a door.

Some embodiments of the present advertising methods include securing a non-portable toilet advertisement to an interior surface of a wall or a door of a portable toilet that has a door, the portable toilet being positioned for use by one or more patrons of an outdoor event.

Some embodiments of the present advertising methods include removably securing a non-electronic, non-portable toilet advertisement to an interior surface of a wall or a door of each portable toilet in a group of portable toilets that are positioned for use by patrons of an outdoor sporting event; and removing one of the non-electric, non-portable toilet advertisements from the interior surface to which it is removably secured after the outdoor sporting event concludes.

Additional embodiments of the present advertising methods, and details associated with those embodiments, are described below.

### BRIEF DESCRIPTION OF THE DRAWINGS

The following drawings illustrate by way of example and not limitation.

FIG. 1 is a perspective view of a prior art portable toilet.

FIG. 2 is a perspective view of the interior of a prior art portable toilet.

FIG. 3 is a perspective view showing a non-portable toilet advertisement that has been secured to an interior surface of a portable toilet wall (more specifically, a rear wall) that is abutted by a sit-down toilet.

FIG. 4 is a perspective view showing a non-portable toilet advertisement that has been secured to an interior surface of a portable toilet wall (more specifically, a side wall) that is abutted by a urinal.

FIG. 5 is a perspective view showing a non-portable toilet advertisement that has been secured to an interior surface of a portable toilet door.

FIG. 6 is a partial view showing a wall (although it could also be a door) of a portable toilet in cross-section, and an advertisement (such as a non-portable toilet advertisement) that has been secured (e.g., removably secured) to an interior surface of the wall using a pressure sensitive adhesive.

FIG. 7 is a partial view showing a wall (although it could also be a door) of a portable toilet in cross-section, and an advertisement (such as a non-portable toilet advertisement) that has been secured (e.g., removably secured) to an interior surface of the wall using two or more substances that are each positioned between the interior surface and the advertisement.

FIG. 8 is a partial view showing a wall (although it could also be a door) of a portable toilet in cross-section, and an advertisement (such as a non-portable toilet advertisement) that has been secured (e.g., removably secured) to an interior surface of the wall using two or more fasteners that are placed through the advertisement and into the wall.

### DESCRIPTION OF ILLUSTRATIVE EMBODIMENTS

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an advertising method that “comprises,” “has,” or “includes” one or more steps possesses those one or more steps, but is not limited to possessing only those one or more steps; it also covers other unlisted steps. Likewise, a step of an advertising method that “comprises,” “has,” or “includes” one or more aspects or features possesses those one or more aspects or features, but is not limited to possessing only those one or more aspects or features; it also covers other unlisted aspects or features. Furthermore, a structure (e.g. a portable toilet) that is configured in a certain way must be configured in at least that way, but also may be configured in a way or ways that are not specified so long as they are not excluded. The terms “a” and “an” are defined as one or more than one unless this disclosure explicitly requires otherwise.

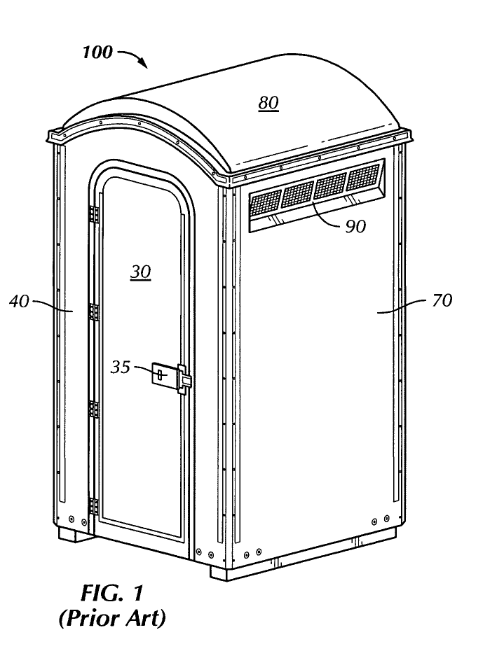

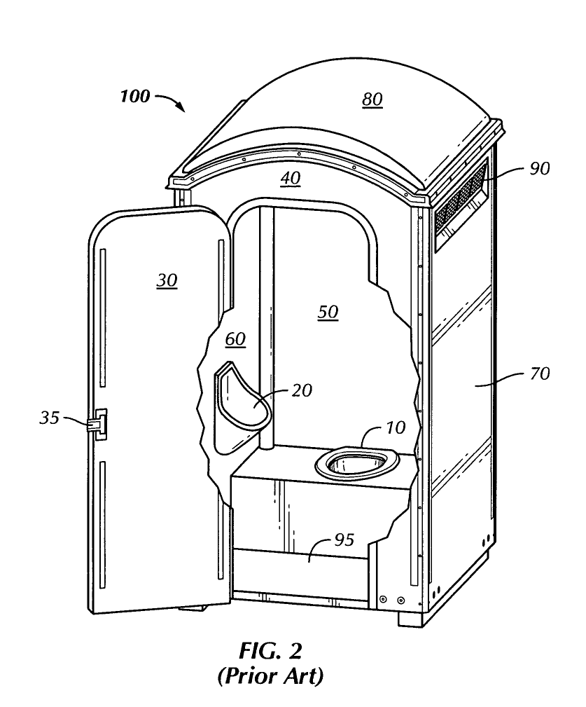

FIGS. 1 and 2 show closed and open views, respectively, of a conventional prior art portable toilet 100 that has at least one sit-down toilet 10 and at least one urinal 20. In some embodiments, portable toilet 100 can be configured to have multiple sit-down toilets 10 and/or multiple urinals 20, and the present advertising methods can be used in conjunction with such versions of portable toilet 100. Portable toilet 100 also has a door 30 bordered by a front wall 40, a rear (or back) wall 50, and two side walls 60 and 70, a roof (in this case an arch-shaped roof) 80, vents 90 positioned in the side walls, and a floor 95. Door 30 includes a handle 35 that can be operated by a user to unlock (e.g., by sliding laterally), lock (e.g., by sliding laterally), and/or pull open the door. In some embodiments, portable toilet 100 can be configured to have multiple doors, and the present advertising methods can be used in conjunction with such versions of portable toilet 100. Portable toilet 100 can be characterized as a “covered” portable toilet because it has a roof. Portable toilet 100 does not include a receiver coupled to or otherwise part of it that accepts money, cards or the like (e.g., a fee) prior to allowing a user to open the door and use the facilities, although it could have such a receiver in some embodiments. Portable toilets that can be used with some of the present advertising methods may be connected to wheels (such as wheels sized for use on the road—like a trailer) and trailered to their final, or near-final, location. Such portable toilets may also (as many any of the portable toilets with which at least some of the present advertising methods may be used) segregate male and female toilets from each other. Examples of such portable toilets include the BLACK TIE series of portable restroom facilities offered by Black Tie Services, Inc. The versions of portable toilets to which wheels are not connected may be characterized as non-rolling portable toilets.

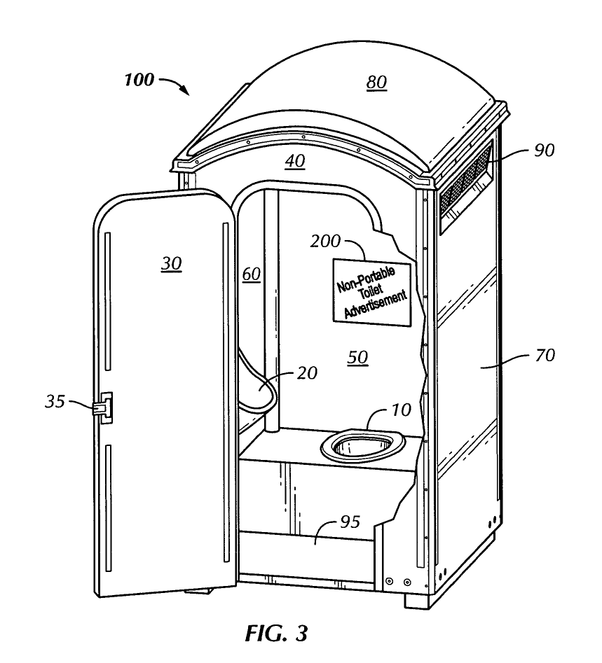

Some embodiments of the present advertising methods include securing an advertisement to an interior surface of a wall or a door of a portable toilet that has a door. One example of the result of such a step is depicted in FIG. 3. This figure shows advertisement 200, which is a non-portable toilet advertisement (and, more specifically, a non-electronic, non-portable toilet advertisement) in the depicted embodiment, that has been secured to an interior surface of rear wall 50 of portable toilet 100. Rear wall 50, in this embodiment, is a wall abutted by sit-down toilet 10. The height of advertisement 200 in this embodiment may be chosen to be about eye-level to the typical person that is expected to use sit-down toilet 10 in a standing fashion because such a person will be facing (e.g., generally directly oppositely facing) the advertisement. A “non-electronic, non-portable toilet advertisement” is defined as a non-portable toilet advertisement (defined above) that is not created using electricity (in contrast to, for example, an advertisement appearing on a monitor).

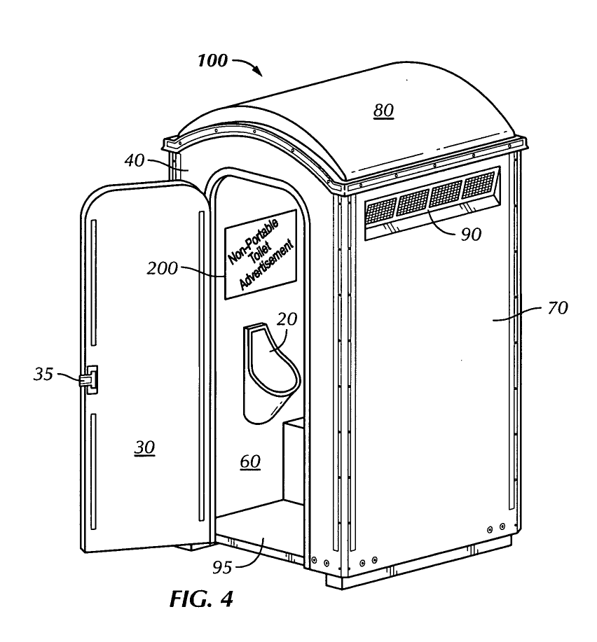

Another example of the result of such a step is depicted in FIG. 4. This figure shows advertisement 200, which is a non-portable toilet advertisement (and, more specifically, a non-electronic, non-portable toilet advertisement) in the depicted embodiment, that has been secured to an interior surface of side wall 60 of portable toilet 100. In this embodiment, side wall 60 is a wall abutted by urinal 20. The height of advertisement 200 in this embodiment may be chosen to be about eye-level to the typical person that is expected to use urinal 20 because such a person will be facing (e.g., generally directly oppositely facing) the advertisement.

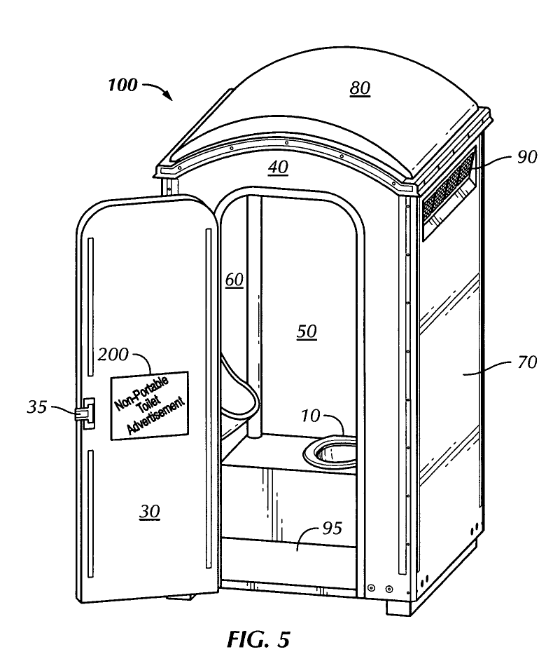

Another example of the result of such a step is depicted in FIG. 5. This figure shows advertisement 200, which is a non-portable toilet advertisement (and, more specifically, a non-electronic, non-portable toilet advertisement) in the depicted embodiment, that has been secured to an interior surface of door 30 of portable toilet 100. The height of advertisement 200 in this embodiment may be chosen to be about eye-level to the typical person that is expected to use sit-down toilet 10 in a sitting fashion because such a person will be facing (e.g., generally directly oppositely facing) the advertisement.

In some embodiments of the present advertising methods, multiple advertisements (e.g., non-portable toilet advertisements, or non-electronic, non-portable toilet advertisements) may be secured to one or more interior surfaces of a wall or door of portable toilet 100, such that a given wall has multiple advertisements secured to it, or multiple walls in a given portable toilet each have an advertisement secured to them.

One manner of securing an advertisement (e.g., non-portable toilet advertisements, or non-electronic, non-portable toilet advertisements) to an interior surface of a wall or a door of portable toilet 100 is to removably secure the advertisement. “Removably securing” an advertisement to a surface is defined as securing the advertisement to the surface in a way that allows the advertisement to be removed and re-used in an effective manner as far as the purchaser/leaser/renter of the advertised service or product is concerned. A removably secured advertisement will not be damaged to a great extent when it is removed.

The number of portable toilets to which advertisements (e.g., non-portable toilet advertisements, or non-electronic, non-portable toilet advertisements) may be secured (e.g., removably secured) can be unlimited. Advertisements may be secured as described above to one or more (e.g., a group of) portable toilets that are positioned for use by patrons (but not only patrons) of an outdoor event, such as a sporting event (e.g., an amateur or professional golf tournament, an amateur or professional tennis tournament, an amateur or professional auto (e.g., car or truck) race, an amateur or professional motorcycle race, an amateur or professional skateboarding competition, an amateur or professional in-line skating competition, an amateur or professional competition involving bicycles, an amateur or professional mixed sporting event (e.g., featuring more than one of the sporting events previously listed), an amateur or professional horse race, an amateur or professional dog race, or the like) or an outdoor concert (e.g., a free outdoor concert, or an outdoor concert for which a ticket must be purchased). The outdoor event may take place during a single day or over multiple days.

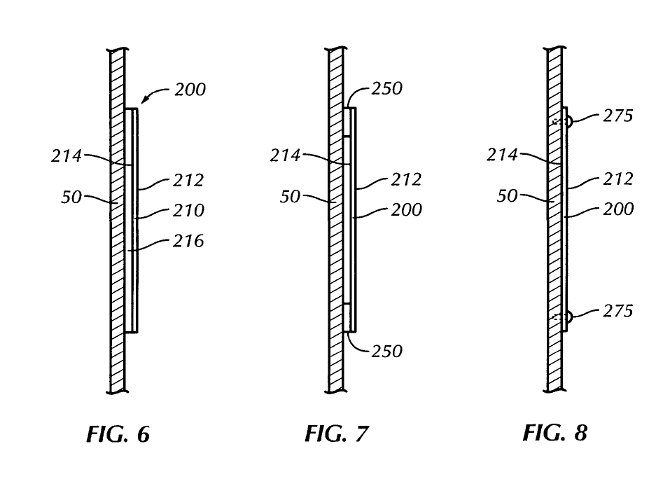

Many different types of advertisements (e.g., non-portable toilet advertisements, or non-electronic, non-portable toilet advertisements) may be used consistent with some embodiments of the present advertising methods. FIG. 6 shows an example of an advertisement that may be either flexible or rigid. In this figure, advertisement 200 (which can be a non-portable toilet advertisement, or a non-electronic, non-portable toilet advertisement) is secured (e.g., removably secured) directly to an interior surface of rear wall 50. The version of advertisement 200 shown in FIG. 6 includes a substrate 210 having a first side 212 and a second side 214. A pressure sensitive adhesive 216 is disposed on second side 214, and advertising indicia (e.g., non-portable toilet advertising indicia, or non-electronic, non-portable toilet advertising indicia) can be disposed on first side 212. A protective sheet (not shown) may be disposed on pressure sensitive adhesive 216 to protect it from being inadvertently stuck to unintended surfaces. The protective sheet may be peeled off prior to securing the advertisement to an intended surface. Substrate 210 may be four one-thousandths of an inch thick. Advertising indicia may be disposed (e.g., permanently disposed) on substrate 210 in any suitable fashion. Pressure sensitive adhesive 216 may be a 13-ounce sticky back pressure sensitive adhesive. FLEXcon Corporation (Spencer, Mass.) can make such an advertisement, and Outdoor America, Inc. (Springdale, Ark.) can supply such an advertisement.

There are a number of substances that could be used instead of pressure sensitive adhesives to secure (and in some cases removably secure) an advertisement to an interior surface of a portable toilet wall or door consistently with some embodiments of the present advertising methods. For example, rubber cement, tape, spray adhesive, sheet adhesive, archival adhesive, contact adhesive, and film adhesive may be used. Other substances suitable for some embodiments includes cyanoacrylates, urethanes, acrylics and epoxies. Glue, wax, paint, foam, plastic and plaster are additional alternatives. Any of these substances may be positioned between an advertisement and an interior surface of a portable toilet wall or door in order to achieve the securing. For example, such substances can used like substances 250 in FIG. 7, which are positioned between advertisement 200 and rear wall. Specifically, one or more substances 250 (which could be any of the substances just mentioned) may be placed in contact with second side 214 of advertisement 200 and the interior surface of rear wall 50. In the embodiment shown in FIG. 7, advertisement 200 is secured directly to the interior surface of rear wall 50 because there is nothing besides substances 250 between advertisement 200 and rear wall 50. In some embodiments in which the advertisement or advertisements used include a pressure sensitive adhesive or other substance, the advertising method also includes cleaning an interior surface prior to securing the advertisement to it.

Fasteners are another alternative to pressure sensitive adhesives. Examples of fasteners that may be used to secure (and in some cases removably secure) advertisements to an interior surface of a portable toilet wall or door consistently with some embodiments of the present advertising methods include tacks, nails, screws, zip screws, push pins, staples, magnets, hook and loop fasteners, and rivets. FIG. 8 shows two fasteners 275 (e.g., screws) that have been used to secure advertisement 200 directly to the interior surface of rear wall 50. Besides fasteners, friction fitted features—such as projections (e.g., stamped projections)—may also be used to perform some of the securing steps described above.

Some embodiments of the present methods include a fee negotiation step that involves negotiating a fee (e.g., an upfront fee, a fee paid after the fact that depends at least in part on how many patrons paid to see a particular event, or the like) with the entity purchasing, leasing or renting the advertising. The fee may pertain in part to the present advertising methods, but may also relate to other advertising that an entity purchases to compliment the present advertising methods (such as scoreboard advertising, or the like). The negotiating may include consideration by the entity (e.g., company or person) providing the advertising services, the entity purchasing/leasing/renting the advertising services, or both, of: (a) an estimated number of individuals who will be exposed to one or more of the advertisements, (b) the number of (e.g., how many) advertisements will be positioned inside at least one or more of the portable toilets in question, and/or (c) the actual physical size of at least some of the advertisements (a larger advertisement may command a higher fee than a smaller advertisement).

Some of the advertisements that may be used consistently with the present advertising methods include a material on which advertising indicia may be placed. Such material may be polymeric or inorganic. The advertising indicia may be placed on the material using any of a variety of suitable methods known in the art. The material may be rigid or it may be flexible.

Some embodiments of the present methods include removing (e.g., non-destructively removing) any or all advertisements (e.g., non-portable toilet advertisements, or non-electronic, non-portable toilet advertisements) that have been secured (e.g., removably secured) to an interior surface of a portable toilet wall or door. The removing may take place in any suitable fashion, and in some embodiments may damage the advertisement to a point that it can no longer be effectively reused. “Non-destructively removing” an advertisement that has been secured (e.g., removably secured) to an interior surface is defined as removing the advertisement in a way that does not damage the advertisement to an extent that it can no longer be effectively reused. The removing may take place after an event (such as an outdoor event, like an outdoor sporting event) has concluded. In some embodiments, an event concludes when all participants have completed the competition. In other embodiments, an event concludes when the last patron leaves the premises on which the event was held. In some embodiments, some or all of the advertisements may be changed out for other advertisements purchased, leased or rented by a different advertiser. Such change-outs may occur multiple times during a given event.

It should be understood that the present advertising methods are not intended to be limited to the particular forms disclosed. Rather, they are to cover all modifications, equivalents, and alternatives falling within the scope of the claims. For example, although some of the present advertising methods have been discussed in terms of use on multiple portable toilets positioned for use by patrons of an outdoor event, some of the present advertising methods are equally applicable to a single portable toilet—or to a relatively small number of portable toilets—that are not positioned for use by patrons of an outdoor event. Such portable toilets may simply be positioned outside a building or on a work site where people gather for any one of many different reasons. Furthermore, although the portable toilet shown in the figures has four walls, those of ordinary skill in the art having the benefit of this disclosure will understand that some of the present methods may be equally applicable to portable toilets with fewer (e.g., one wall shaped like a cylinder) or more than four walls.

The claims are not to be interpreted as including means-plus- or step-plus-function limitations, unless such a limitation is explicitly recited in a given claim using the phrase(s) “means for” or “step for,” respectively.

I claim:

1. An advertising method comprising:
securing an advertisement to an interior surface of a wall or a door of a portable toilet that has a door.

2. The advertising method of claim 1, where a patron can open the door and use the portable toilet without first depositing a fee in a receiver that is coupled to, or otherwise part of, the portable toilet.

3. The advertising method of claim 1, further comprising:
securing a second advertisement to an interior surface of another wall or the door of the portable toilet.

4. The advertising method of claim 3, further comprising:
securing a third advertisement to an interior surface of the door of the portable toilet.

5. The advertising method of claim 1, where the securing comprises securing the advertisement to one portion of an interior surface of a wall of the portable toilet, and the method further comprises securing a second advertisement to another portion of the interior surface of the wall.

6. The advertising method of claim 1, where the securing comprises securing the advertisement to one portion of an interior surface of the door of the portable toilet, and the method further comprises securing a second advertisement to another portion of the interior surface of the door.

7. The advertising method of claim 1, where the portable toilet has one or more sit-down toilets.

8. The advertising method of claim 1, where the portable toilet has one or more urinals.

9. The advertising method of claim 1, where the advertisement includes a substrate having a first side and a second side, advertising indicia disposed on the first side, and a pressure sensitive adhesive disposed on the second side.

10. The advertising method of claim 1, where the securing involves the use of one or more fasteners.

11. The advertising method of claim 1, where the interior surface is part of a wall, and a sit-down toilet abuts the wall.

12. The advertising method of claim 1, where the interior surface is part of the door of the portable toilet.

13. The advertising method of claim 1, where the interior surface is part of a wall, and a urinal abuts the wall.

14. The advertising method of claim 1, where the securing comprises securing an advertisement to an interior surface of a wall or a door of each of a group of portable toilets that each has a door.

15. The advertising method of claim 14, further comprising:
removing the advertisement from the interior surface of each wall or door.

16. The advertising method of claim 1, further comprising:
removing the toilet advertisement from the interior surface.

17. An advertising method comprising:
securing a non-portable toilet advertisement to an interior surface of a wall or a door of a portable toilet that has a door, the portable toilet being positioned for use by one or more patrons of an outdoor event.

18. The advertising method of claim 17, where a patron can open the door and use the portable toilet without first depositing a fee in a receiver that is coupled to, or otherwise part of, the portable toilet.

19. The advertising method of claim 17, further comprising:
securing a second non-portable advertisement to an interior surface of another wall or the door of the portable toilet.

20. The advertising method of claim 19, further comprising:
securing a third non-portable toilet advertisement to an interior surface of the door of the portable toilet.

21. The advertising method of claim 17, where the securing comprises securing the non-portable toilet advertisement to one portion of an interior surface of a wall of the portable toilet, and the method further comprises securing a second non-portable toilet advertisement to another portion of the interior surface of the wall.

22. The advertising method of claim 17, where the securing comprises securing the non-portable toilet advertisement to one portion of an interior surface of the door of the portable toilet, and the method further comprises securing a second non-portable toilet advertisement to another portion of the interior surface of the door.

23. The advertising method of claim 17, where the outdoor event comprises a sporting event or a concert event.

24. The advertising method of claim 17, where the portable toilet has one or more sit-down toilets.

25. The advertising method of claim 17, where the portable toilet has one or more urinals.

26. The advertising method of claim 17, where the non-portable toilet advertisement includes a substrate having a first side and a second side, non-portable toilet indicia disposed on the first side, and a pressure sensitive adhesive disposed on the second side.

27. The advertising method of claim 17, where the securing involves the use of one or more fasteners.

28. The advertising method of claim 17, where the interior surface is part of a wall, and a sit-down toilet abuts the wall.

29. The advertising method of claim 17, where the interior surface is part of the door of the portable toilet.

30. The advertising method of claim 17, where the interior surface is part of a wall, and a urinal abuts the wall.

31. The advertising method of claim 17, where the securing comprises securing a non-portable toilet advertisement to an interior surface of a wall or a door of each portable toilet having a door in a group of portable toilets, each portable toilet in the group being positioned for use by one or more patrons of the outdoor event.

32. The advertising method of claim 31, further comprising:
removing the non-portable toilet advertisement from the interior surface of each wall or door.

33. The advertising method of claim 17, further comprising:
removing the non-portable toilet advertisement from the interior surface.

34. An advertising method comprising:
removably securing a non-electronic, non-portable toilet advertisement to an interior surface of a wall or a door of each portable toilet in a group of portable toilets that are positioned for use by patrons of an outdoor sporting event; and
removing one of the non-electric, non-portable toilet advertisements from the interior surface to which it is removably secured after the outdoor sporting event concludes.

35. The advertising method of claim 34, further comprising:
negotiating a fee to be paid in return for, at least in part, the removably securing, the negotiating involving consideration of: (a) an estimated number of individuals who will be exposed to one or more of the non-electric, non-portable toilet advertisements, (b) how many non-electric, non-portable toilet advertisements will be positioned inside at least one or more portable toilets in the group, and/or (c) the size of at least some of the non-electric, non-portable toilet advertisements.

36. The advertising method of claim 34, where a patron can open the door and use each portable toilet without first depositing a fee in a receiver that is coupled to, or otherwise part of, that portable toilet.

37. The advertising method of claim 34, further comprising:
removably securing a second non-electronic, non-portable advertisement to an interior surface of another wall or the door of each portable toilet.

38. The advertising method of claim 37, further comprising:
removably securing a third non-electronic, non-portable toilet advertisement to an interior surface of the door of each portable toilet.

39. The advertising method of claim 34, where the removably securing comprises removably securing a non-electronic, non-portable toilet advertisement to one portion of an interior surface of a wall of each portable toilet, and the method further comprises securing a second non-electronic, non-portable toilet advertisement to another portion of the interior surface of the wall of each portable toilet.

40. The advertising method of claim 34, where the removably securing comprises removably securing a non-electronic, non-portable toilet advertisement to one portion of an interior surface of the door of each portable toilet, and the method further comprises removably securing a second non-portable toilet advertisement to another portion of the interior surface of the door of each portable toilet.

41. The advertising method of claim 34, where each portable toilet has one or more sit-down toilets.

42. The advertising method of claim 34, where each portable toilet has one or more urinals.

43. The advertising method of claim 34, where each non-electronic, non-portable toilet advertisement includes a substrate having a first side and a second side; non-electronic, non-portable toilet indicia disposed on the first side; and a pressure sensitive adhesive disposed on the second side.

44. The advertising method of claim 34, where the removably securing involves the use of one or more fasteners.

45. The advertising method of claim 34, where the interior surface is part of a wall of each portable toilet, and a sit-down toilet abuts that wall.

46. The advertising method of claim 34, where the interior surface is part of the door of each portable toilet.

47. The advertising method of claim 34, where the interior surface is part of a wall of each portable toilet, and a urinal abuts that wall.

48. The advertising method of claim 34, further comprising:
removing each non-electric, non-portable toilet advertisements from the interior surface to which it is removably secured after the outdoor sporting event concludes.
